(19) United States
(12) Patent Application Publication
(10) Pub. No.: US 2004/0239778 A1
(43) Pub. Date: Dec. 2, 2004

(54) Digital camera and method of controlling same

(76) Inventor: Takashi Soga, Asaka-shi (JP)

Correspondence Address: BIRCH STEWART KOLASCH & BIRCH, PO BOX 747, FALLS CHURCH, VA, 22040-0747, US

(21) Appl. No.: 10/852,221

(22) Filed: May 25, 2004

(30) Foreign Application Priority Data
May 26, 2003 (JP) 2003-147495

(51) Int. Cl. H04N 5/262

(52) U.S. Cl. 348/239

(57) ABSTRACT

Light representing the image of a subject is obtained by a zoom lens and the light is split into first and second light beams by a beam splitter. The first light beam impinges upon a CCD, whereby image data representing the image of a subject is obtained. The second light beam impinges upon a thermal sensor, whereby data representing the thermal distribution of the subject is obtained. A combining circuit generates a composite image by combining the image of the subject and the image of the thermal distribution. The composite image is displayed. The user finds the position of a main subject while observing the composite image. Pressing a shutter-release button causes the image data representing the image of the subject to be recorded on a memory card.

### BACKGROUND OF THE INVENTION

1. Field of the Invention

This invention relates to a digital camera (inclusive of a digital still camera, digital movie camera and a portable information device having a camera function) and to a method of controlling the operation thereof.

2. Description of the Related Art

Surveillance cameras are installed at locations that need to be monitored. The monitored location is imaged by the surveillance camera and if a suspicious person intrudes, then the image of the suspicious person is sensed. Some surveillance cameras not only image a monitored location but also measure the temperature and humidity, etc., of the monitored area and can detect changes in the temperature and humidity of the monitored location (see the specification of Japanese Patent Application Laid-Open No. 10-178567).

However, a surveillance camera of this kind merely measures temperature and humidity and does not give consideration to the thermal distribution of the subject under surveillance.

### SUMMARY OF THE INVENTION

Accordingly, an object of the present invention is to locate a main subject based upon the thermal distribution of subjects and record image data representing the image of the subject.

According to the present invention, the foregoing object is attained by providing a digital camera comprising an imaging optical system for forming an optical image representing the image of a subject; a solid-state electronic image sensing device, which has a photoreceptor surface, for outputting image data representing the image of the subject formed on this photoreceptor surface by the imaging optical system; a thermal sensor, which has a photoreceptor surface, for outputting data representing a thermal distribution of the subject represented by the image of the subject formed on the photoreceptor surface by the imaging optical system; a display device for displaying a thermal-distribution image of the subject represented by thermal-distribution data output from the thermal sensor; and a recording controller for recording image data, which has been output from the solid-state electronic image sensing device, on a recording medium.

The present invention provides also a method of controlling operation of the digital camera described above. Specifically, the present invention provides a method of controlling operation of a digital camera having an imaging optical system for forming an optical image representing the image of a subject, the method comprising the steps of: outputting image data, which represents the image of the subject formed on a photoreceptor surface by the imaging optical system, from a solid-state electronic image sensing device; outputting data representing a thermal distribution of the subject, which is represented by the image of the subject formed on a photoreceptor surface by the imaging optical system, from a thermal sensor; displaying on a display device a thermal-distribution image of the subject represented by thermal-distribution data output from the thermal sensor; and recording image data, which has been output from the solid-state electronic image sensing device, on a recording medium.

It may be so arranged that the image of a subject is formed on the photoreceptor surface of the solid-state electronic image sensing device using a first imaging optical system and the image of a main subject is formed on the photoreceptor surface of the thermal sensor using a second imaging optical system.

In accordance with the present invention, an optical image representing the image of a subject is formed on the photoreceptor surface of a solid-state electronic image sensing device and on the photoreceptor surface of a thermal sensor. The solid-state electronic image sensing device outputs image data representing the image of the subject, and the thermal sensor outputs data representing the thermal distribution of the subject. A thermal-distribution image of the subject represented by the thermal-distribution data is displayed on the display screen of a display device. The image data output from the solid-state electronic image sensing device is recorded on a recording medium.

Since the image representing the thermal distribution of the subject is displayed on the display screen of the display device, the main subject can be found while viewing the image representing this thermal distribution and the camera angle can be decided accordingly. Even if the position of the main subject is difficult to ascertain, as at night, the position of the main subject can be determined based upon the thermal distribution and the camera angle can be decided accordingly. In a case where image data representing the image of a subject is recorded on the recording medium by photography at night, flash photography would be used.

The camera further comprises a beam splitter for splitting light, which has been condensed by the imaging optical system, into light introduced to the photoreceptor surface of the solid-state electronic image sensing device and light introduced to the photoreceptor surface of the thermal sensor.

Preferably, the camera further comprises a combining device for combining the image of the subject represented by image data output from the solid-state electronic image sensing device and the thermal-distribution image represented by thermal-distribution data output from the thermal sensor, and generating a composite image. In this case the display device would display the composite image produced by the combining means.

The camera may further comprise a threshold-value setting device for setting a thermal threshold value. In this case the thermal sensor would output data representing a thermal distribution above the threshold value that has been set by the threshold-value setting means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical structure of a digital still camera according to the present invention;

FIGS. 2A, 2B and 2C illustrate an image obtained by photography, a thermal-distribution image and a composite image, respectively;

FIG. 3 illustrates an example of a zoomed image;

FIG. 4 illustrates an example of a recorded image; and

FIG. 5 is a flowchart illustrating recording processing according to the present invention.

### DESCRIPTION OF THE PREFERRED EMBODIMENT

A preferred embodiment of the present invention will now be described in detail with reference to the drawings.

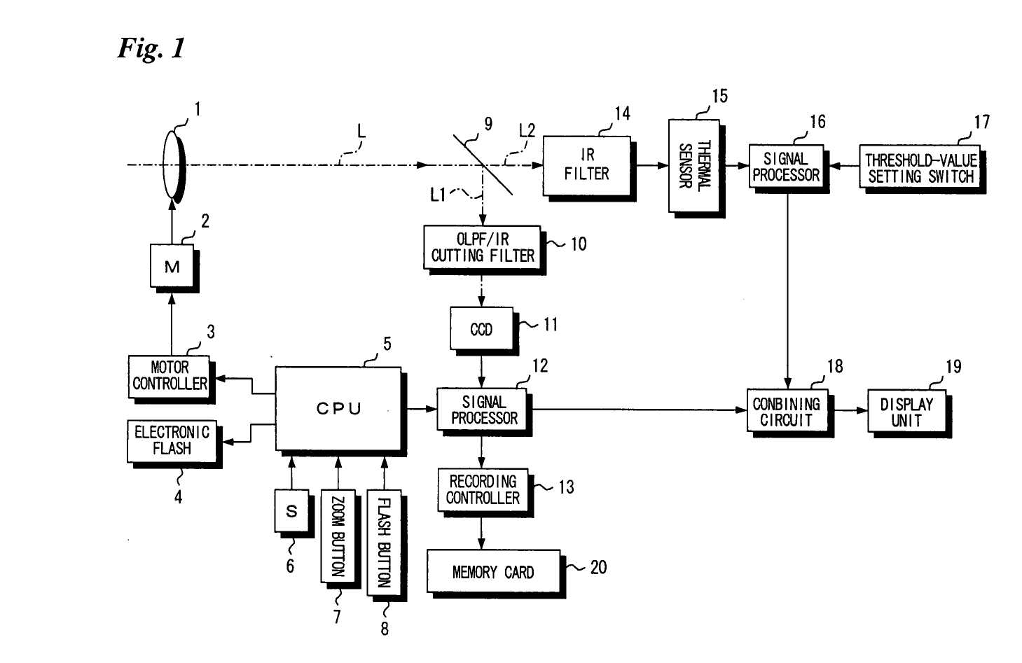

FIG. 1 is a block diagram illustrating the electrical structure of a digital still camera according to a preferred embodiment of the present invention.

The overall operation of the digital still camera is controlled by a CPU 5.

The digital still camera includes a shutter-release button 6, a zoom button 7 and a flash button 8. Signals indicating that the buttons 6, 7 and 8 have been pressed are input to the CPU 5.

The digital still camera further includes an electronic flash unit 4. A flash photography mode is set and the flash unit 4 emits light in response to pressing of the flash button 8.

The digital still camera further includes a zoom lens 1 for forming an optical image representing the image of a subject. The amount of zoom of the zoom lens 1 is controlled by a zoom motor 2 controlled by a motor controller 3.

Light L condensed by the zoom lens 1 is split into two light beams L1 and L2 by a beam splitter 9.

One light beam L1 impinges upon the photoreceptor surface of a CCD 11 though an OLPF (optical low-pass filter)/IR (infrared) cutting filter 10. The image of the subject is formed on the photoreceptor surface of the CCD 11 as a result. A video signal representing the image of the subject is output by the CCD 11 and enters a signal processing circuit 12. The latter subjects the video signal to prescribed signal processing such as an analog-to-digital conversion, a gamma correction and a white balance adjustment and inputs the processed signal to a combining circuit 18 and recording control circuit 13 as image data.

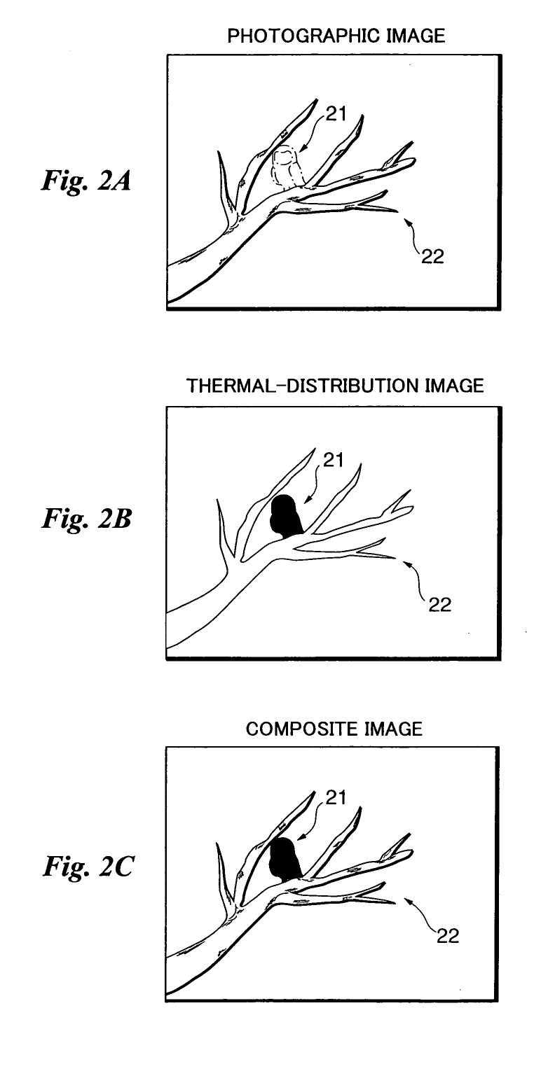

FIG. 2A illustrates an example of an image (referred to as a “photographic image” below) represented by image data that is output from the signal processing circuit 12.

Here the subject is dark and an image 21 of a main subject is indistinct in comparison with an image 22 of the surrounding subject. Since the image 21 of the main subject is indistinct and difficult to see, it is difficult to decide a camera angle centered on the image 21 of the main subject even if the photographic image is observed.

With reference again to FIG. 1, the other light beam L2 of the two light beams L1 and L2 obtained by the splitting operation of the beam splitter 9 impinges upon the photoreceptor surface of a thermal sensor 15 via an IR filter 14. The image of the subject is formed on the photoreceptor surface of the thermal sensor 15 in a manner similar to that of the CCD 11. The IR filter 14 passes only the infrared region of the incident light and causes the infrared image to be formed on the thermal sensor 15. By way of example, the thermal sensor 15 can employ an area sensor identical with a monochrome CCD that forms an image of infrared light. The thermal sensor 15 outputs a video signal in the infrared-wavelength region representing the thermal distribution of the subject.

The video signal that is output from the thermal sensor 15 is input to a signal processing circuit 16. In a manner similar to that of the signal processing circuit 12, the signal processing circuit 16 subjects the input video signal to prescribed signal processing such as an analog-to-digital conversion, a gamma correction and a white balance adjustment.

A thermal threshold value from a threshold-value setting switch 17 also is applied to the signal processing circuit 16. Data representing a thermal distribution above the threshold value provided by the threshold-value setting switch 17 is input to the combining circuit 18 from the signal processing circuit 16.

FIG. 2B illustrates an example of a thermal-distribution image represented by thermal-image data that is output from the signal processing circuit 16.

The image 21 of the main subject has a temperature higher than that of the surrounding image 22. Consequently, the image 21 of the main subject is displayed blacker (or whiter) in comparison with the surrounding image 22. Since the image 21 of the main subject is more noticeable than the surrounding image 22, it is easier to decide a camera angle centered on the image 21 of the main subject.

With reference again to FIG. 1, the combining circuit 18 combines the photographic image represented by the image data that enters from the signal processing circuit 12 and the thermal-distribution image represented by the thermal-distribution data that enters from the signal processing circuit 16, thereby generating composite-image data. The composite-image data produced by the combining circuit 18 is applied to a display unit 19. The composite image of the photographic image and thermal-distribution image is displayed on the display screen of the display unit 19.

FIG. 2C illustrates an example of the composite image represented by the composite-image data.

Since the composite image is synthesized in such a manner that the thermal-distribution image is displayed with regard to the image 21 of the main subject and the photographic image is displayed with regard to the surrounding image 22, the image 21 of the main subject is noticeable. By observing the composite image, the user can decide the camera angle. In addition, it is easier to ascertain the position of the main subject.

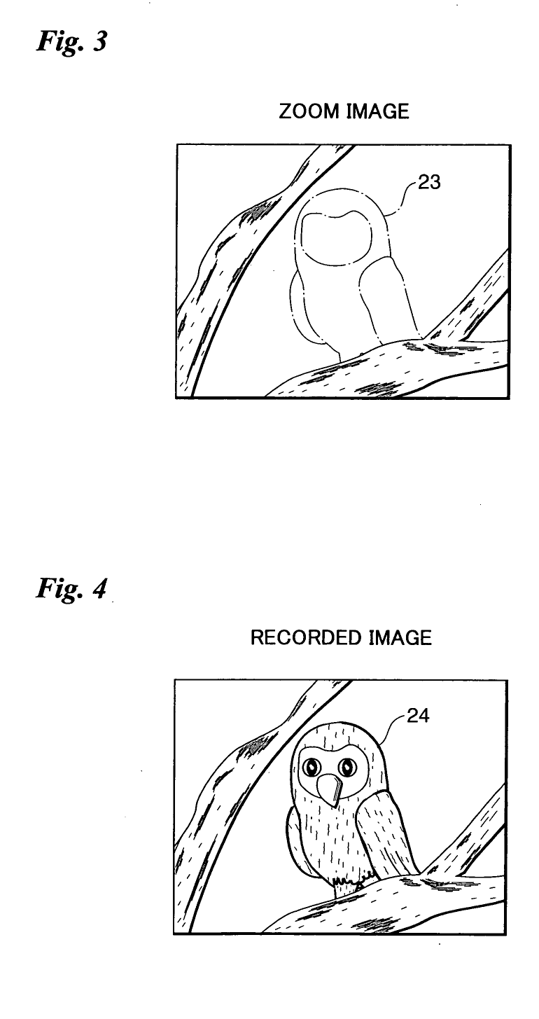

If it is desired to enlarge the image 21 of the main subject, then the zoom button 7 is pressed, in conformity with which the amount of zoom of the zoom lens 1 is adjusted. An enlarged image 23 of the main subject is displayed on the display screen of the display unit 19, as shown in FIG. 3.

If the flash photography mode is set by the flash button 8 and the shutter-release button 6 is pressed, a flash light emission is produced by the flash unit 4. Image data of high luminance is obtained from the signal processing circuit 12 and input to the recording control circuit 13. The high-luminance image data is recorded on a memory card 20 by the recording control circuit 13.

FIG. 4 illustrates an example of an image (a recorded image) represented by the image data recorded on the memory card 20.

The image 23 of the main subject in the recorded image is enlarged and captured by flash photography and therefore is comparatively large and bright, as mentioned above.

Even if the location is dark, as at night, the main subject can be found and the image can be recorded at a camera angle that is more appropriate.

In the above-described embodiment, a photographic image and a thermal-distribution image are combined to produce a composite image that is displayed on the display screen of the display unit 19. However, the composite image need not necessarily be displayed. By displaying the thermal-distribution image on the display screen of the display unit 19, the image of the main subject can be found by viewing the thermal-distribution image even if the subject is dark. It goes without saying that after the image of the main subject is found, the image data representing the photographic image is recorded on the memory card 20 in response to pressing of the shutter-release button 6.

In the embodiment above, flash photography is carried out. However, it goes without saying that an arrangement may be adopted in which image data representing a photographic image is recorded on the memory card 20 without performing flash photography.

Furthermore, in the embodiment above, the light beam L representing the image of the subject is split into the two light beams L1 and L2 using the beam splitter 9. However, it may be so arranged that light beams representing the image of a subject impinge upon respective ones of the CCD 11 and thermal sensor 15 via two identical zoom lenses, or by taking in and out a total reflection mirror.

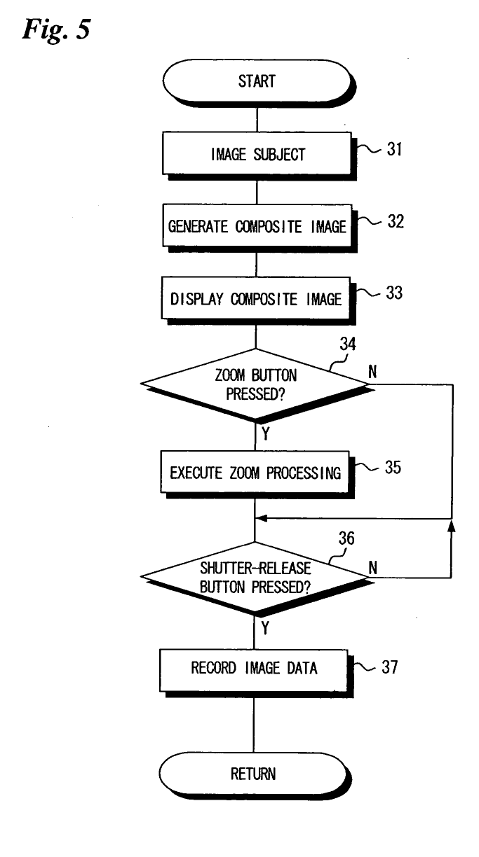

FIG. 5 is a flowchart illustrating recording processing.

A subject is imaged by the CCD 11 and thermal sensor 15 (step 31). Image data representing a photographic image and image data representing a thermal distribution is input to the combining circuit 18, which proceeds to generate image data representing a composite image (step 32). The composite image is displayed on the display screen of the display unit 19 by applying the generated composite-image data to the display unit 19 (step 33).

If the zoom button 7 is pressed (“YES” at step 34), the zoom position of the zoom lens 1 is adjusted in conformity with the pressing of this button (step 35). If the zoom button 7 is not pressed (“NO” at step 34), then the processing of step 35 is skipped.

If the shutter-release button 6 is pressed (“YES” at step 36), the image data representing the photographic image that is output from the signal processing circuit 12 is recorded on the memory card 20 (step 37).

Although the CCD 11 is used in the above embodiment, the C-MOS sensor can be used for the CCD 11.

As many apparently widely different embodiments of the present invention can be made without departing from the spirit and scope thereof, it is to be understood that the invention is not limited to the specific embodiments thereof except as defined in the appended claims.

What is claimed is:

1. A digital camera comprising:
an imaging optical system for forming an optical image representing the image of a subject;
a solid-state electronic image sensing device, which has a photoreceptor surface, for outputting image data representing the image of the subject formed on this photoreceptor surface by said imaging optical system;
a thermal sensor, which has a photoreceptor surface, for outputting data representing a thermal distribution of the subject represented by the image of the subject formed on this photoreceptor surface by said imaging optical system;
a display device for displaying a thermal-distribution image of the subject represented by thermal-distribution data that is output from said thermal sensor; and
a recording controller for recording image data, which has been output from said solid-state electronic image sensing device, on a recording medium.

2. The digital camera according to claim 1, further comprising a beam splitter for splitting light, which has been condensed by said imaging optical system, into light introduced to the photoreceptor surface of said solid-state electronic image sensing device and light introduced to the photoreceptor surface of said thermal sensor.

3. The digital camera according to claim 1, further comprising a combining device for combining the image of the subject represented by image data output from said solid-state electronic image sensing device and the thermal-distribution image represented by thermal-distribution data output from said thermal sensor, and generating a composite image;
wherein said display device displays the composite image generated by said combining device.

4. The digital camera according to claim 1, further comprising a threshold-value setting device for setting a thermal threshold value;
wherein said thermal sensor outputs data representing a thermal distribution above the threshold value that has been set by said threshold-value setting means.

5. A method of controlling operation of a digital camera having an imaging optical system for forming an optical image representing the image of a subject, said method comprising the steps of:
outputting image data, which represents the image of the subject formed on a photoreceptor surface by the imaging optical system, from a solid-state electronic image sensing device having this photoreceptor surface;
outputting data representing a thermal distribution of the subject, which is represented by the image of the subject formed on a photoreceptor surface by the imaging optical system, from a thermal sensor having this photoreceptor surface;
displaying on a display device a thermal-distribution image of the subject represented by thermal-distribution data that is output from the thermal sensor; and
recording image data, which has been output from the solid-state electronic image sensing device, on a recording medium.
